(19) United States
(12) Patent Application Publication
(10) Pub. No.: US 2003/0042807 A1
(43) Pub. Date: Mar. 6, 2003

(54) System and device to drive generators or alternators to charge batteries in electrically powered vehicles

(76) Inventor: Alexander Blake, Lake Worth, FL (US)

Correspondence Address: Alexander Blake, 1837 East Terrace Drive, Lake Worth, FL, 33460, US

(21) Appl. No.: 09/940,958

(22) Filed: Aug. 28, 2001

(51) Int. Cl. H02K 7/00; H02K 11/00

(52) U.S. Cl. 310/66

(57) ABSTRACT

The system and device of the present invention is designed for the purpose of providing a charging apparatus to charge the drive system battery or batteries and a service system battery in electrically powered vehicles while the vehicle is operated, thereby extending the driving range of such vehicle. Though spent energy can not be totally replace, a considerable portion of the spent energy from the batteries can be replaced while the vehicle is operated.

### BACKGROUND OF THE INVENTION

Though the development of electrically powered vehicles has progressed steadily, the driving range of such vehicles is still restricted due to the depletion of energy in the drive system battery or batteries of the vehicle and the lack of reliable and constant charging devices. The use of solar energy is limited by weather conditions and the size of solar panels, required to supply sufficient energy replacement to the battery or batteries. In contrast to the so called “hybrid” vehicles, using small conventional engines to assist, which are being produced on a limited basis, the charging system and device of the present invention does not require the assist as used in these vehicles. The present invention is designed to increase the driving range of electrically powered vehicles to approach or even exceed that of conventionally powered vehicles.

### SUMMARY OF THE INVENTION

The present invention provides a power spring driven main gear, main friction wheel, main pulley, main sprocket or, as illustrated on drawings 4, 5 and 6, a power spring driven main wheel. The main gear, main friction wheel, main pulley, main sprocket or main wheel drive a set of gears, friction wheels, pulleys, sprockets or, as illustrated in the second design, as illustrated on drawings 4,5, and 6, a gear type power transmission. Other types of suitable power transmission devices may also be used, as long as sufficient RPM, required for the generators or alternators to charge the batteries, are achieved while the vehicle is operated, thus increasing the driving range of the vehicle.

The main gear, main friction wheel, main pulley or main sprocket, as illustrated on drawings 1, 2 and 3 and the main wheel as illustrated in the second design shown on drawings 4, 5 and 6, are powered by a power spring. The outer end of the power spring is attached to the main gear, main friction wheel, main pulley, main sprocket or, using a power transmission design as illustrated on drawings 4, 5 and 6, to the main wheel. The inner end of the power spring is attached to the ratchet wheel or the ratchet wheel shaft or axle. Other types of restrictive devices may be used instead of the ratchet wheel and ratchet pawl. When signaled by a power spring tension sensor to wind the power spring, a switch operates the power spring winding motor with speed reducer to wind the power spring. The electricity to the power spring winding motor is supplied by the service system battery which also supplies the electric power to the lights, windshield wiper, windows etc. A ratchet pawl prevents the ratchet from turning and thereby the power spring from unwinding immediately upon completion of the winding operation. An electromagnetic or other type of brake, simultaneously with the start of the power spring winding operation, stops the main gear, main friction wheel, main pulley, main sprocket or, in a power transmission device, as for axample, illustrated on drawings 4, 5 and 6, from turning with the winding of the power spring.

### DESCRIPTION OF THE DRAWING

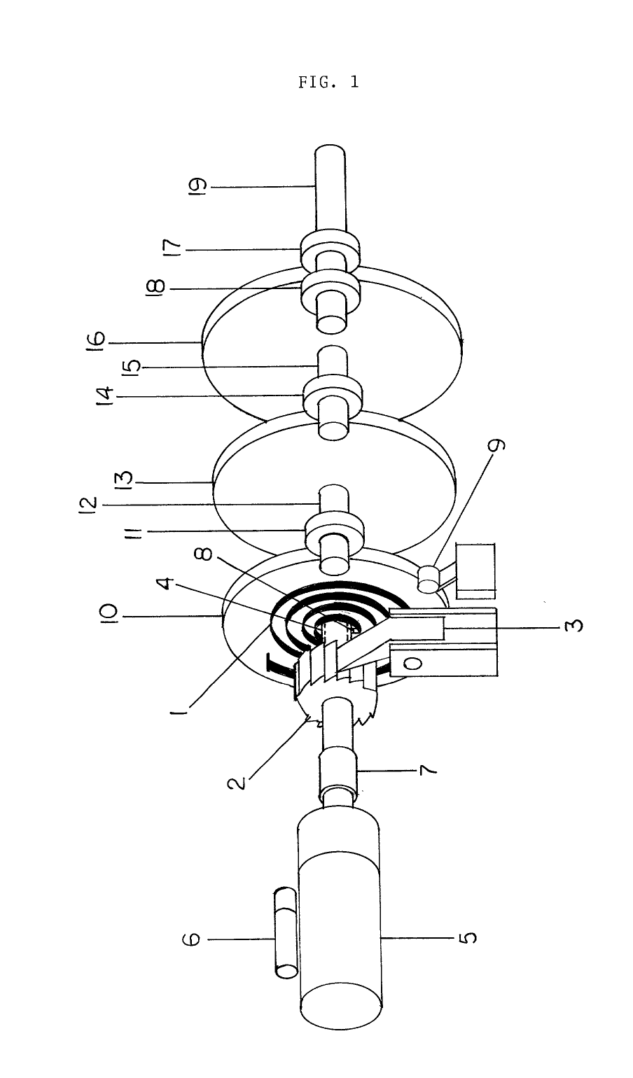

### FIG. 1

1) Power spring

2) Ratchet wheel

3) Ratchet pawl

4) Ratchet wheel shaft or axle

5) Power spring winding motor with speed reducer

6) Switch

7) Coupling

8) Power spring tension sensor

9) Electro-magnetic or other type brake

10) Main gear, main friction wheel, main pulley or main sprocket

11) Small gear, friction wheel, pulley or sprocket

12) Axle

13) Large gear, friction wheel, pulley or sprocket

14) Small gear, friction wheel, pulley or sprocket

15) Axle

16) Large gear, friction wheel, pulley or sprocket

17) Small gear, friction wheel, pulley or sprocket

18) Pulley

19) Axle

### DESCRIPTION OF THE DRAWING

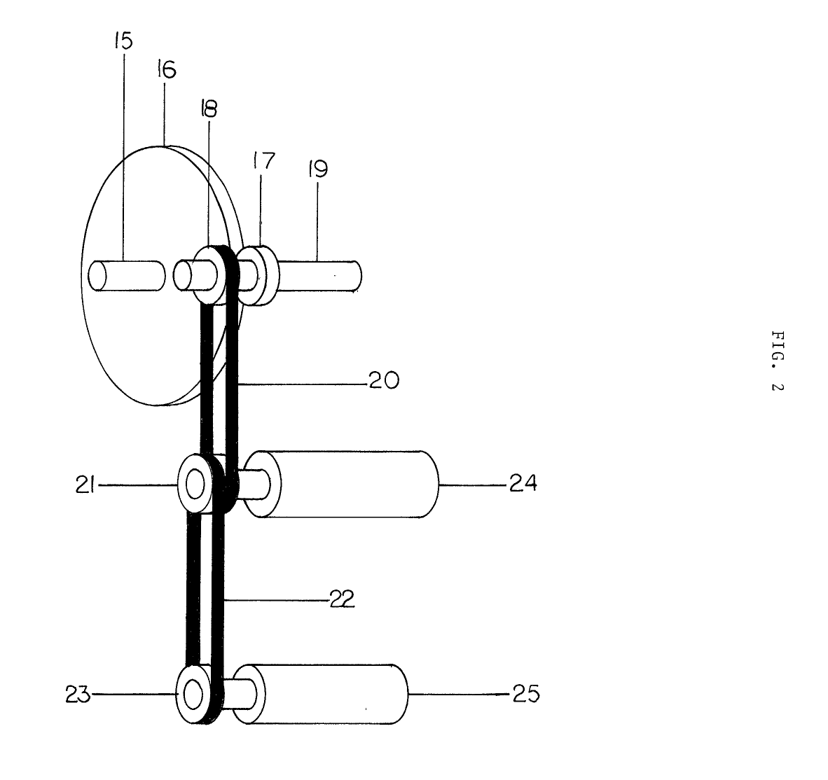

### FIG. 2

15) Axle

16) Large gear, friction wheel, pulley or sprocket

17) Small gear, friction wheel, pulley or sprocket

18) Pulley

19) Axle

20) Belt

21) Double pulley

22) Belt

23) Pulley

24) Drive system battery charging generator or alternator

25) Service system battery charging generator or alternator

### DESCRIPTION OF THE DRAWING

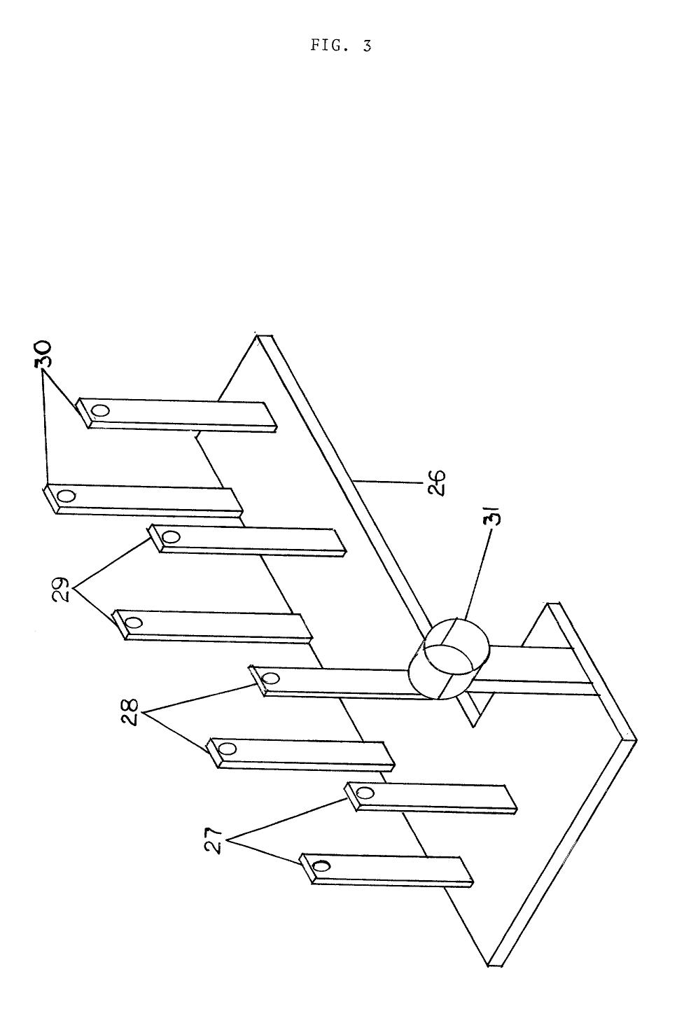

### FIG. 3

26) Base

27) Supports for main gear, main friction wheel, main pulley or main sprocket axle

28) Supports for axle 12

29) Supports for axle 15

30) Supports for axle 19

31) Mount and support for power spring winding motor with speed reducer

### DESCRIPTION OF THE DRAWING

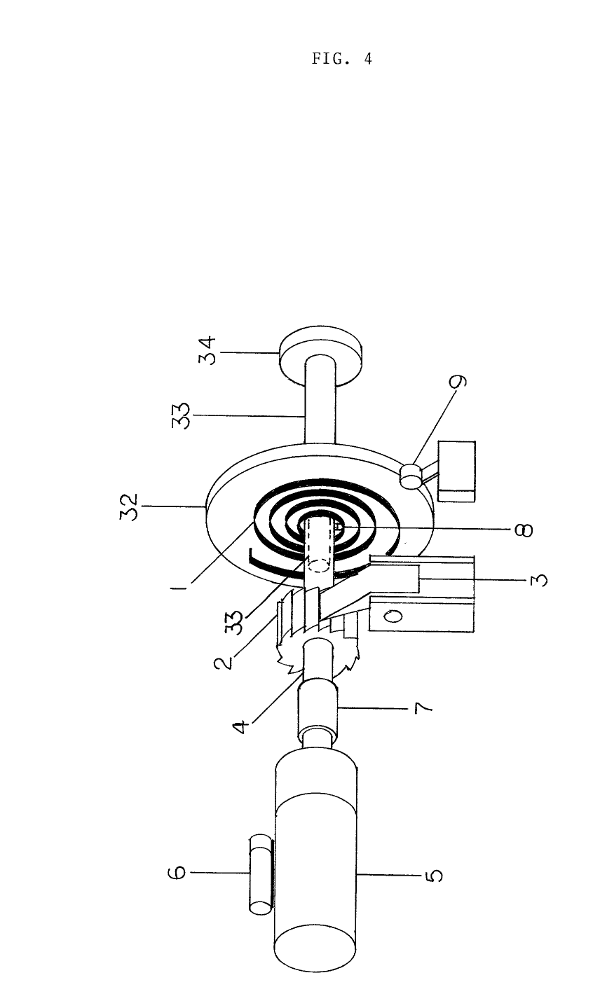

### FIG. 4

1) Power spring

2) Ratchet wheel

3) Ratchet pawl

4) Ratchet wheel shaft or axle

5) Power spring winding motor with speed reducer

6) Switch

7) Coupling

8) Power spring tension sensor

9) Electro-magnetic or other type brake

34) Large gear

### DESCRIPTION OF THE DRAWING

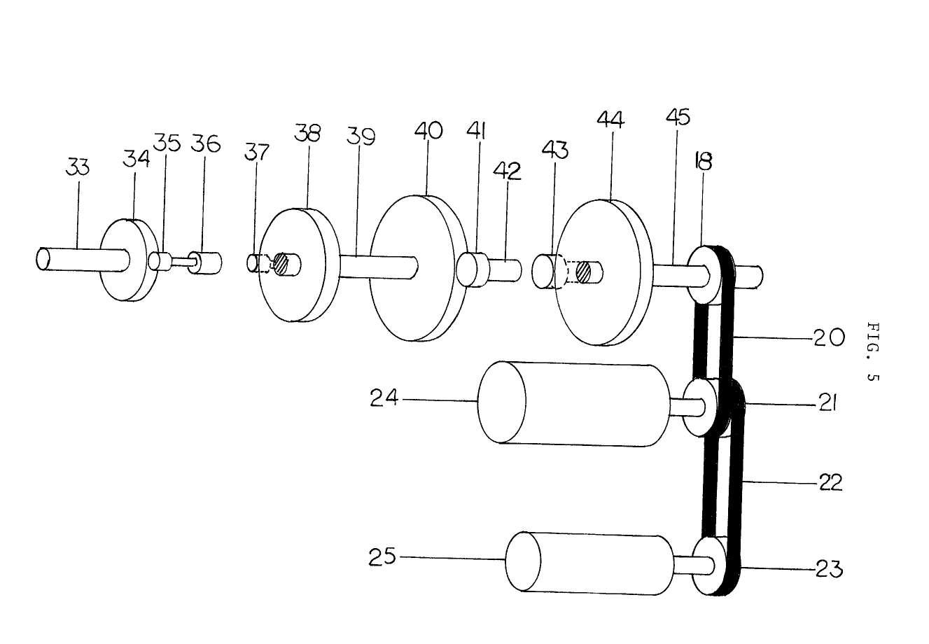

### FIG. 5

18) Pulley

20) Belt

21) Double pulley

22) Belt

23) Pulley

24) Drive system battery charging generator or alternator

25) Service system battery charging generator or alternator

32) Main wheel

33) Shaft or axle

34) Large gear

35) Small gear

36) Shaft or axle

37) Small gear

38) Large gear

39) Shaft or axle

40) Large gear

41) Small gear

42) Shaft or axle

43) Small gear

44) Large gear

45) Shaft or axle

### DESCRIPTION OF THE DRAWING

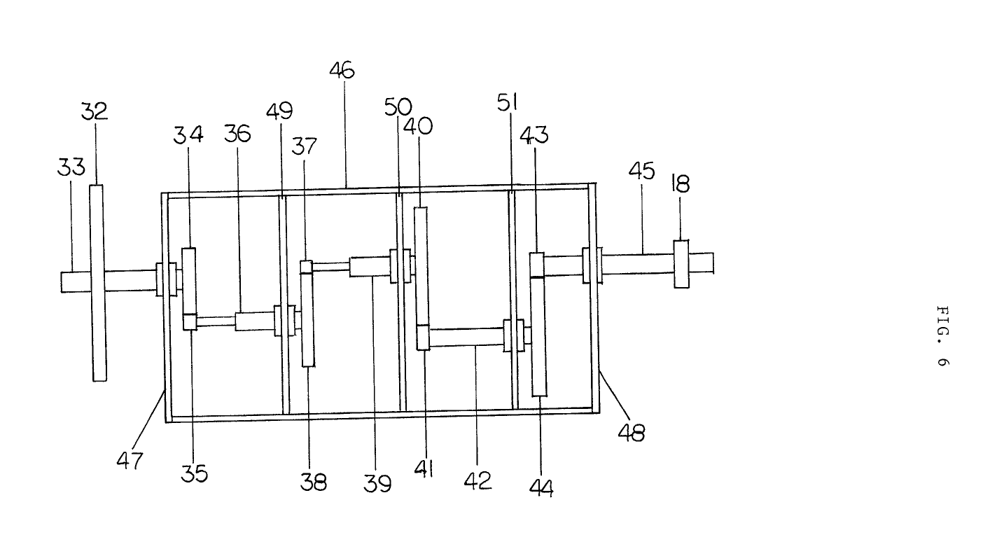

### FIG. 6

18) Pulley

32) Main wheel

33) Shaft or axle

34) Large gear

35) Small gear

36) Shaft or axle

37) Small gear

38) Large gear

39) Shaft or axle

40) Large gear

41) Small gear

42) Shaft or axle

43) Small gear

44) Large gear

45) Shaft or axle

46) Transmission housing

47) Front cover with bearing

48) Rear cover with bearing

49) Support web with bearing

50) Support web with bearing

51) Support web with bearing

### DETAILED DESCRIPTION OF THE PREFERRED EMBODIMENTS

The present invention provides a system and device to charge the drive system battery or batteries and a service system battery during operation of an electrically powered vehicle, thereby increasing the operating range of the vehicle.

The system and device of the present invention is described in two designs, using different power transmission devices, though any suitable power transmission design may be used, as long as sufficient RPM of the generators or alternators are achieved to charge the batteries.

The first design of the present invention is illustrated on drawings 1, 2 and 3 in which the outer end of the power spring 1 is attached to the main gear, main friction wheel, main pulley or main sprocket 10 and the inner end of the power spring 1 is attached to the ratchet wheel 2 or, as illustrated, to the ratchet wheel shaft 4. An electric motor with speed reducer 5 winds the power spring 1 when contacts are closed in switch 6 upon a signal from the power spring tension sensor 8 to switch 6. The power spring tension sensor 8 may be of a laser type, light sensor, photocell, toggle switch or other suitable type. Simultaneously with the signal from the power spring tension sensor 8 to switch 6, a signal is also send to an electro-magnetic or other suitable type brake 9 which engages the main gear, main friction wheel, main pulley or main sprocket 10 to momentarily prevent same from turning with the winding or the power spring 1. When the power spring tension sensor 8 signals the switch 6 to interrupt the current to the power spring winding motor with speed speed reducer 5, upon completion of the winding operation, it also interrupts the current to the electromagnetic or other type brake 9, thereby releasing same.

The electromagnetic or other type brake 9 is equipped with a spring which retracts the brake 9 to release same. When the tension of the power spring 1 is reduced to a point when winding is required, the power spring tension sensor 8 signals the switch 6 to close contacts and start the power spring winding motor with speed reducer 5 to wind the power spring 1 by turning the ratchet wheel 2 which is engaged by the ratchet pawl 3 to prevent unwinding of the power spring 1 during the winding operation and to hold the inner end of the power spring 1 fast while same unwinds during the turning of the main gear, main friction wheel, main pulley or main sprocket 10. The gear, friction wheel, pulley or sprocket 13 turns a gear, friction wheel, pulley or sprocket 14 of reduced diameter or pitch circle, which is mounted on a common shaft or axle 15 with gear, friction wheel, pulley or sprocket 16 with a diameter or pitch circle greater than that of gear, friction wheel, pulley or sprocket 13. The gear, friction wheel, pulley or sprocket 16 turns a gear, friction wheel, pulley or sprocket 17 of reduced diameter. A pulley 18 is mounted on the common shaft or axle 19 with the gear, friction wheel, pulley or sprocket 17. In the case of pulley or sprocket, belts or roller chain would be used respectively. The pulley 18 is mounted on shaft or axle 19, but is located outside the support 30 to facilitate changing the belt 20 without removal of shaft or axle 19. A belt 20 connects pulley 18 with a double pulley 21 of the drive system battery charging generator or alternator 24, thus turning same. A second belt 22 connects the double pulley 21 with the pulley 23 of the service system battery charging generator or alternator 25, thus turning same. Preferably, the pulleys 18, 21 and 23 should be of the same diameter or pitch circle as gear, friction wheel, pulley or sprocket 17. In case of the use of generators, the appropriate voltage regulators have to be used. The generators or alternators 24 and 25 may be located so that the system and device of the present invention requires the least amount of space, either in line with gears, friction wheels, pulleys or sprockets 16 and 17, or above or below of same. Other types of power transmission devices may be used, as long as it is driven by a power spring device per the present invention and as long as the required RPM of the generators or alternators are achieved to assure sufficient charging of the batteries.

The supports 28 and 29 are staggered or offset to allow for clearance of the shaft or axle of the previous gear, friction wheel, pulley or sprocket. The power spring winding motor with speed reducer support 31 is situated in line with the supports 27 of the main gear, main friction wheel, main pulley or main sprocket 10. The supports are mounted or are attached to a common base 26. The main gear, main friction wheel, main pulley or main sprocket 10 turns in supports 27 and the other gears, friction wheels, pulleys or sprockets turn in supports 28, 29 and 30 respectively with the use of bearing bushings or bearings.

As an example, the following is a demonstration of the RPM generated by the system and device of the present invention: Assuming a main gear, main friction wheel, main pulley or main Sprocket 10 with a diameter or pitch circle of 18 inches; a gear, friction wheel, pulley or sprocket 11 with a diameter or pitch circle of 3 inches; a gear, friction wheel, pulley or sprocket 13 with a diameter or pitch circle of 21 inches; a gear, friction wheel, pulley or sprocket 14 with a diameter or pitch circle of 3 inches; a gear, friction wheel, pulley or sprocket 16 with a diameter or pitch circle of 24 inches; a gear, friction wheel, pulley or sprocket 17 with a diameter or pitch circle of 3 inches and pulleys 18, 21 and 23 with a diameter of 3 inches.

As the main gear, main friction wheel, main pulley or main sprocket 10 turns 1 time, the gear, friction wheel, pulley or sprocket 11 turns 6 times. Therefore, gear, friction wheel, pulley or sprocket 13 turns 6 times. With every revolution of gear, friction wheel, pulley or sprocket 13, gear, friction wheel, pulley or sprocket 14 turns 7 times. Therefore, gear, friction wheel, pulley or sprocket 16 turns 7 times. With every revolution of gear, friction wheel, pulley or sprocket 16, gear, friction wheel, pulley or sprocket 17, and therefore pulleys 18, 21 and 23 turn 8 times.

Therefore, the RPM of pulleys 18, 21 and 23 and the generators or alternators 24 and 25 are calculated as follows:

18″÷3″=6

21″÷3″=7

24″÷3″=8

1×6=6×7=42×8=336

Therefore, with every revolution of the power spring 1 driven main gear, main friction wheel, main pulley or main sprocket 10, the gear, friction wheel, pulley or sprocket 17, as well as pulleys 18, 21 and 23 turn 336 times. If the main gear, main friction wheel, main pulley or main sprocket turns only, for example, at 10 RPM, the gear, friction wheel, pulley or sprocket 17 and the pulleys 18, 21 and 23 turn at 3360 RPM.

The diameter or pitch circle of the main gear, main friction wheel, main pulley or main sprocket 10 may be selected to be 12 inches, the gear, friction wheel, pulley or sprocket 11 to be 2 inches, the gear, friction wheel, pulley or sprocket 13 to be 14 inches, the gear, friction wheel, pulley or sprocket 14 to be 2 inches, the gear, friction wheel, pulley or sprocket 16 to be 16 inches, the gear, friction wheel, pulley or sprocket 17 to be 2 inches, and the pulleys 18, 21 and 23 to be 2 inches. The RPM generated would be identical to the above example. However, this selection would result in a smaller system and device of the present invention, thereby requiring less space. The generated RPM can also simply be changed, up or down, by changing the diameter of the pulleys 18, 21 and 23.

The power spring 1 may be selected to provide tension to either increase or decrease the RPM of the system and device of the present invention as required to provide the maximum and most efficient charging rate of the generators or alternators 24 and 25 as is needed to keep the batteries charged as fully as possible.

The alternative and preferable design of a system and device of the present invention, as illustrated on drawings 4, 5 and 6, utilizes a more compact power transmission device, though any suitable power transmission may be used as long as the result is sufficient RPM of the generators or alternators to charge the batteries when the vehicle is operated.

In this design of the present invention the outer end of the power spring 1 is attached to a main wheel 32. The inner end of the power spring 1 is attached to the ratchet wheel 2 or, preferably to the ratchet wheel shaft or axle 4. An electric motor with speed reducer 5 winds the power spring 1 when contacts are closed in switch 6 upon a signal from the power spring tension sensor 8 to switch 6. The power spring tension sensor 8 may be of a laser type, light sensor, photocell, toggle switch or other suitable type. Simultaneously with the signal from the power spring tension sensor 8 to switch 6, a signal is also send to an electromagnetic or other type brake 9 which engages the main wheel 32 to momentarily prevent same from turning with the winding of the power spring 1. When the power spring tension sensor 8 signals the switch 6 to interrupt the current to the power spring winding motor with speed reducer 5, upon completion of the winding operation, it also releases the electromagnetic or other type brake 9.

The electromagnetic or other type brake is equipped with a spring or other type retraction device to release same. A calliper type brake may also be used. When tension of the power spring 1 is reduced to a point when winding is required, the power spring tension sensor 8 signals the switch 6 to close contacts and start the power spring winding motor with speed reducer 5 to wind the power spring 1 by turning the ratchet wheel 2 and thereby the ratchet wheel shaft or axle 4. The ratchet wheel 2 is engaged by a ratchet pawl 3 to prevent unwinding of the power spring 1 during the winding operation and to hold the inner end of the power spring 1 fast while same unwinds during the turning of the main wheel 32.

The ratchet wheel shaft or axle 4 is attached to the shaft of the power spring winding motor with speed reducer 5 with the use of a coupling 7. The axle 33 of the main wheel 32 and gear 33 turns either inside or outside of the shaft or axle 4 of the ratchet wheel 2 with the use of a bearing bushing or needle bearing, or other type of bearing.

The power spring 1 drives the main wheel 32. With the common shaft or axle 33, the main wheel 32 drives the gear 33 directly, in contrast to the first described design. The gear 33 drives a gear 35 with a reduced pitch circle, which is mounted on a common shaft or axle 36 with large gear 38. The large gear 38 turns a gear 37 with a reduced pitch circle. A common shaft or axle 39 connects the small gear 37 with the large gear 40. The large gear 40 turns a small gear 41. The shaft or axle 42 of small gear 41 connects same with the large gear 44. The large gear 44 turns a small gear 43. A pulley 18 is mounted on the shaft or axle 45 of the small gear 43. A belt 20 connects with the double pulley 21 of the drive system generator or alternator 24, thus turning same. The belt 22 connects the double pulley 21 with the pulley 23 of the service system generator or alternator, thus turning same.

The shaft or axle 33 turns in a bearing which is in the front cover 47 of the transmission housing 46. The shaft or axle 36 turns in a bearing attached to the support web 49. The shaft or axle 39 is supported with a bearing in support web 50. The shaft or axle 42 is supported with a bearing mounted in support 51. The shaft or axle 45 turns in a bearing mounted in the rear cover 48 of the transmission housing 46.

As an example, the following is a demonstration of the RPM generated by the second and preferable design of a system and device of the present invention:

Assuming a gear 34 with a pitch circle of 4 inches; a gear 35 with a pitch circle of 1 inch; a gear 38 with a pitch circle of 6 inches; a gear 37 with a pitch circle of 1 inch; a gear 40 with a pitch circle of 8 inches; a gear 41 with a pitch circle of 2 inches; a gear 44 with a pitch circle of 8 inches; a gear 43 with a pitch circle of 2 inches.

As the main wheel 32 turns 1 time, gear 34 turns 1 time. With every revolution of gear 34, the gear 35 turns 4 times. Therefore, gear 38 turns 4 times. With every revolution of gear 38, the gear 37 turns 6 times. Since with every revolution of the gear 34 the gear 38 turns 4 times, the gear 37 turns 24 times, which results in gear 40 turning 24 times. With every revolution of gear 40, the gear 41 turns 4 times, which results in gear 41 turning 96 times. Therefore, gear 44 turns 96 times. With every revolution of gear 44, the gear 43 turns 4 times and therefore 384 times with every revolution of gear 34.

Therefore, the RPM of pulleys 18, 21 and 23 and the generators or alternators 24 and 25 can be calculated as follows:

4″÷1″=4

6″÷1″=6

8″÷2″=4

8″÷2″=4

1×4=4×6=24×4=96×4=384

Therefore, with every revolution of the power spring driven main wheel 32 and gear 34, the pulleys 18, 21 and 23 turn 384 times. If the main wheel 32 turns only, for example, at 10 RPM, the pulleys 18, 21 and 23 and therefore the generators or alternators 24 and 25 turn 3840 times.

The diameter of pulley 18 may be selected to either increase or decrease the generated RPM.

What is claimed is:

1) An electromechanical system and device to drive battery charging generators or alternators in electrically powered vehicles.

2) A system and device per claim 1, utilizing a power spring to drive a main gear, main friction wheel, main pulley, main sprocket or main wheel.

3) A system and device per claim 1, utilizing a power transmission powered by a power spring driven main gear, main friction wheel, main pulley, main sprocket or main wheel.

4) A system and device per claims 1 and 2, utilizing a power spring tension.

5) A system and device per claim 1, utilizing an electric motor with speed reducer to wind the power spring.

6) A system and device per claim 1, utilizing a ratchet wheel and ratchet pawl or other suitable device to prevent the power spring fron unwinding during the winding operation and to hold the inner end fast while the outer end turns the main gear, main friction wheel, main pulley, main sprocket or main wheel.

7) A system and device per claim 1, utilizing an electro-magnetic brake or other device to stop the main gear, main friction wheel, main pulley, main sprocket or main wheel during the winding of the power spring.

8) A system and device per claim 1, utilizing a switch to start and control the power spring winding motor with speed reducer.
